(19) United States
(12) Patent Application Publication
(10) Pub. No.: US 2013/0032541 A1
(43) Pub. Date: Feb. 7, 2013

(54) SULFOLANE REMOVAL SYSTEM

(71) Applicants: Marc Coggeshall, Wichita, KS (US); Shannon Price, Salcha, AK (US)

(72) Inventors: Marc Coggeshall, Wichita, KS (US); Shannon Price, Salcha, AK (US)

(21) Appl. No.: 13/196,697

(22) Filed: Aug. 2, 2011

(51) Int. Cl. C02F 1/28; C02F 1/58

(52) U.S. Cl. 210/663; 210/694

(57) ABSTRACT

Sulfolane is removed from contaminated groundwater by passing the contaminated groundwater through a filtration system to form purified water having drinking water quality. The filtration system includes untreated activated carbon having no biological remediation component. The filtration system may be a point-of-entry system designed for use in a residential location, and includes one or more primary carbon adsorption tanks and at least one secondary carbon adsorption tank. The primary carbon adsorption tank(s) and secondary carbon adsorption tank are charged with granular activated carbon. The filtration system optionally includes a sediment filter and a water softener.

### FIELD

The present invention relates to water purification systems, and in particular to point-of-entry systems for removing contaminants from groundwater.

### BACKGROUND

Sulfolane is a clear, colorless liquid used in the petroleum-refining industry as an extractive solvent for removal of aromatic compounds from aliphatic hydrocarbon mixtures. Sulfolane has the following chemical structure:

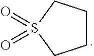

Sulfolane is a highly-polar compound with good chemical and thermal stability and thus can be reused many times. It is fully water soluble and has low volatility, vapor pressure, octanol-partition coefficient (K_{ow}), and Henry's Law constant. Based on these chemical properties, sulfolane is highly mobile in water. Thus, when sulfolane does contaminate groundwater it is difficult to remove therefrom. Where major groundwater supplies are impacted, bulk filtration systems can be employed at the point of extraction prior to introducing the water to the municipal water supply.

Groundwater contamination of private wells, however, presents a more difficult problem. Alternate water supply options in these cases include providing bottled water to those affected, installation of bulk water tank systems, and in-home water treatment systems (also known as point-of-entry (POE) treatment systems).

Studies have investigated the ability of microorganisms to degrade sulfolane in refinery wastewater and groundwater using activated sludge. Aerobic degradation in an activated sludge system was found to cause a significant drop in pH due to the production of sulfuric acid, thus terminating microbial activity. Additional studies have documented aerobic sulfolane degradation with addition of nutrients such as phosphate and nitrogen. Sulfolane is expected to be essentially nonvolatile based on the low Henry's Law constant and low vapor pressure.

Other studies have investigated removal of sulfolane from groundwater via aerobic biodegradation, oxidation with hydrogen peroxide, oxidation with ultraviolet (UV) radiation, and oxidation with hydrogen peroxide and UV radiation. These studies concluded that hydrogen peroxide and UV radiation provided the greatest degree of sulfolane removal (95 percent), due largely to the reactivity of hydroxyl radicals produced by interaction between the hydrogen peroxide and ultraviolet radiation. However, this reaction took days to complete, making this filtration technique impractical for POE systems.

Limited studies have been conducted to evaluate the suitability of using activated carbon to remove sulfolane from groundwater. One such study was focused on whether biological activated carbon could be effective in removing sulfolane from groundwater. This study did not, however, consider whether sulfolane could be removed from the water to drinking water quality, and suggests that untreated activated carbon is not suitable for use in removing sulfolane from groundwater. Moreover, POE systems for removing sulfolane from groundwater using biological activated carbon or untreated activated carbon were not considered.

Faster and more efficient processes for removing sulfolane from groundwater are thus desirable. It would be particularly desirable to provide a POE system for removing sulfolane from contaminated groundwater.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

In one embodiment, sulfolane-contaminated groundwater is passed through a filtration system to form purified water. The filtration system includes activated carbon as the remediation component.

In other embodiments, the purified water has less than 10 parts per billion sulfolane.

In further embodiments, the activated carbon is untreated and does not include a biological remediation component.

In yet other embodiments, the filtration system is a point-of-entry system. The filtration system may be installed in a residential location.

In certain embodiments, the filtration system includes one or more primary carbon adsorption tanks and at least one secondary carbon adsorption tank. The adsorption tanks may be chaged with granular activated carbon.

In other embodiments the filtration system can further include a sediment filter and a water softener.

In further embodiments the sulfolane-contaminated groundwater is passed through the filtration system at a maximum flowrate of about 6 gallons per minute.

In yet other embodiments the sulfolane-contaminated groundwater has a sulfolane concentration of up to 350 parts per billion.

In other embodiments the filtration system includes two primary carbon adsorption tanks and one secondary carbon adsorption tank, and the two primary carbon adsorption tanks are arranged in a parallel configuration.

### BRIEF DESCRIPTION OF THE FIGURES

Illustrative embodiments of the present invention are described in detail below with reference to the following drawing figures:

FIG. 1A is a schematic diagram of a bench testing configuration.

FIG. 1B is a schematic diagram of another bench testing configuration.

FIG. 1C is a schematic diagram of yet another bench testing configuration.

FIG. 2 is a schematic diagram of a filtration system according to one embodiment of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Screening-level testing was conducted to evaluate the suitability of the following methods for removing sulfolane from water: potassium permanganate oxidation; calcium hypochlorite oxidation; oxidation via ultraviolet radiation (UV oxidation); hydrogen peroxide oxidation; hydrogen peroxide and UV oxidation; and activated carbon adsorption.

The results of the screening-level testing indicated that activated carbon adsorption showed promise for use in a potential POE system and a more detailed feasibility study was conducted. Hydrogen peroxide with UV oxidation and ozone oxidation showed more limited promise but were included in the feasibility study.

The overall goals for the feasibility study were to demonstrate the ability of these technologies to remove sulfolane from groundwater to drinking water quality (<10 ppb), and to characterize the general level of effort (i.e., reaction time, empty bed contact time, carbon changeout frequency, etc) required to reliably achieve nondetectable levels of sulfolane in the treated water. In general, a low required level of effort supports design goals, including “carefree” operation, minimizing inconvenience to the homeowners to facilitate system operation and maintenance, minimizing system footprint, and the use of readily-available commercial components.

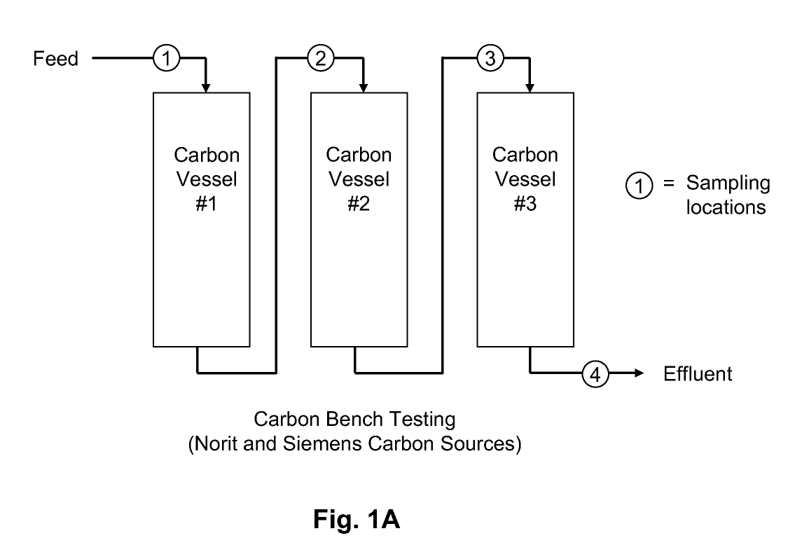

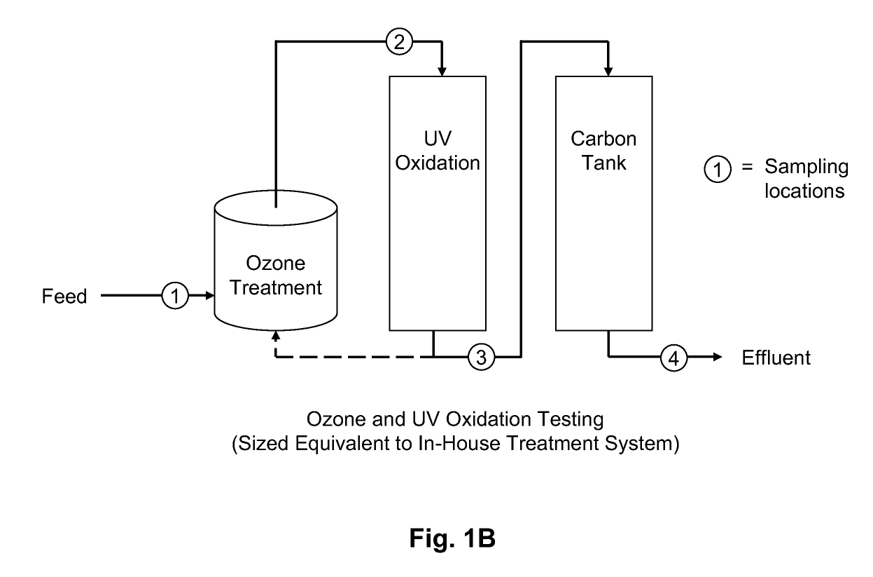

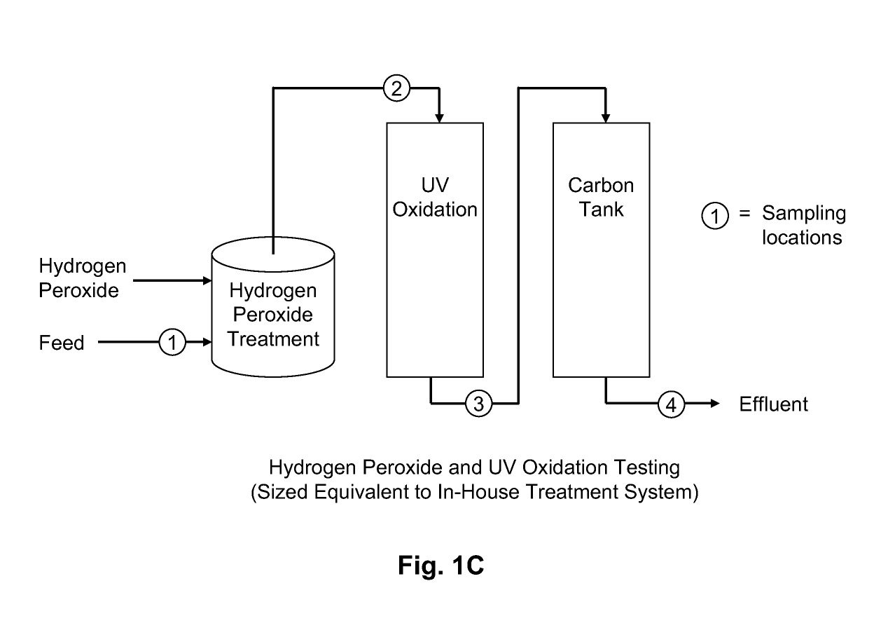

A bench-testing protocol was developed for the feasibility study. With reference to FIGS. 1A-1C, the bench-testing equipment included two sets of test columns for activated carbon testing and two oxidative treatment setups (i.e., oxidant mix tanks/feed equipment, UV lamp, and carbon for oxidant quenching) as dictated by the applicable testing protocol.

Activated Carbon Bench Testing

The objective of activated carbon testing was to evaluate the required empty bed contact time (EBCT), and activated carbon replacement interval (time to breakthrough) for a system treating sulfolane in residential drinking water. The EBCT determined during bench testing can be used as one criteria to size the full-scale carbon system, based on flow. The time to breakthrough determined in bench testing can be used to calculate the required carbon volume necessary to achieve a given carbon replacement frequency by scaling to the sulfolane mass-loading rate.

Based on the low octanol-water partition coefficient of sulfolane, it was anticipated that a relatively long (up to 20 minutes) EBCT would be required to achieve adsorption of sulfolane to the carbon. In order to test the effect of EBCT on adsorption of sulfolane, each of the test sets was loaded with a different type of activated carbon—Norit® GCA 830 and Siemens Aquacarb® 830C. Each column in the set of three was loaded with 0.17 cubic feet of carbon. A flow rate of 0.1 gpm was applied to each column set, providing a total EBCT of 38 minutes across each set, or about 12 minutes across each column. Source water for the test was from a residential well having sulfolane concentrations averaging about 320 μg/L.

The water was fed through the columns for a period of 24 hours, and samples were collected for sulfolane analysis from the feed, effluent, and between each column every 60 minutes (in'accordance with standard carbon column testing protocol provided by Norit) for the duration of the test. Additionally, samples for analysis of total organic carbon (TOC), iron, manganese, and alkalinity were collected from the feed and effluent from each of the columns to provide characterization of other aspects of water quality that could potentially affect activated carbon performance. The flow rate through the columns was also measured every 60 minutes, as were the pH and temperature at each of the sample locations.

It was anticipated that, if a long EBCT were required, early breakthrough would be observed in the lead columns. If no breakthrough was observed in any of the columns for the duration of the test, then the columns would be reloaded with fresh carbon and fed at 0.3 gpm, thus providing a total EBCT of 12 minutes across three columns, and an EBCT of about 4 minutes across each column, and the sampling protocol repeated. If no breakthrough was observed in any of the columns at the 0.3 gpm flow rate, it would be concluded that an EBCT of about 4 minutes would be sufficient to achieve adsorption of sulfolane to the carbon. A 4-minute EBCT falls into the range commonly used in routine activated carbon filtration applications for drinking water. Thus, if a 4-minute EBCT can be demonstrated to be effective, then standard-sized residential carbon tanks would be capable of achieving the necessary EBCT for sulfolane adsorption.

Once the necessary EBCT was determined, the time to breakthrough (i.e., total adsorptive capacity) for the carbon was determined. The time to breakthrough, along with feed flow rate and feed sulfolane concentrations, can be used to determine how long a cubic foot of carbon will effectively remove sulfolane in a full-scale application by scaling to the mass-loading rate (pounds sulfolane adsorbed per cubic foot of activated carbon). The protocol for determining the time to breakthrough involved running feed water through the Siemens carbon at 0.3 gpm and sampling at regular intervals until breakthrough was observed in the first column. The practice of collecting contemporaneous samples of feed and effluent from each column was continued, as was the collection of samples for TOC, iron, manganese, and alkalinity to confirm the consistency of feed-water quality.

Hydrogen Peroxide with UV Bench Testing

The objective of this testing was to evaluate the incremental benefit of including oxidative pretreatment using hydrogen peroxide with ultraviolet radiation in the POE treatment train. For the hydrogen peroxide system, the bench apparatus was equipped with a 20-gallon mix tank, in which 12% hydrogen peroxide was dosed at a rate of 2 cubic centimeters per minute. It was assumed that a full-scale mix tank volume of 120 gallons would be used in a residential application for the hydrogen peroxide system (maximum feed rate of 6 gpm). Thus, flow through the bench system was 1 gpm to provide a representative 20-minute residence time in the mix tank. Quantification of the actual hydrogen peroxide concentration in solution was attempted; however, it was higher than the measurement limits of the field monitoring device and assumed to be more than sufficient to support creation of hydroxyl radicals during exposure to UV radiation based on typical hydrogen peroxide concentrations used in other water treatment applications.

Two different UV units were tested with the hydrogen peroxide system. The first UV unit included three sequential 254-nm UV bulbs. It was thought, however, that placing the three bulbs in a single pipe rather than three sequential pipes would achieve greater UV intensity and, therefore, more effective sulfolane oxidation. Thus, a second UV unit with three 254-nm bulbs contained in a single vessel was also obtained and tested. Finally, it was also thought that including a UV bulb that emitted in the 185-nm wavelength may further enhance sulfolane oxidation. Thus, one of the 254-nm bulbs in the aforementioned single-vessel UV unit was replaced with a 185-nm bulb for the final test with peroxide plus UV. The final component of the oxidation setups was a carbon tank to quench excess oxidant.

The three 254-nm UV bulbs in series were tested by feeding the bench apparatus at 0.5 and 1 gpm and collecting samples of the feed, mix tank effluent, UV system effluent, and carbon tank effluent. The duration of the test run was 60 minutes, with samples collected at 20, 40, and 60 minutes. Samples were collected for analysis of sulfolane, TOC, iron, manganese, alkalinity, VOCs, and SVOCs.

The three 254-nm UV bulbs in a single vessel were tested by feeding the bench apparatus at three different flow rates (1 gpm, 1.5 gpm, and 2 gpm) to produce three different residence times (approximately 2 minutes, 1.5 minutes, and 1 minute) in the UV vessel. Samples were collected from the feed, mix tank effluent, UV effluent, and carbon effluent after 20 minutes of run time at each of the three flow rates. Samples were collected for analysis of sulfolane, TOC, iron, manganese, and alkalinity.

The two 254-nm bulbs and one 185-nm UV bulb in a single vessel were tested in a similar manner.

Ozone with UV Bench Testing

The objective of this testing was to evaluate the incremental benefit of including oxidative pretreatment using ozone or ozone with ultraviolet radiation in the POE treatment train.

For the ozone system, a mix tank with a volume of approximately 120 gallons was contemplated for the full-scale/in-house systems, which would receive a maximum flow rate of 6 gpm, providing a residence time of 20 minutes in the mix tank. The bench apparatus was therefore equipped with a 20-gallon ozone mixing tank, such that a feed rate of 1 gpm would provide a representative 20-minute residence time. Ozone was supplied to the mix tank via an ozone generator with a capacity of 5 grams/hour. The UV unit with three bulbs in one vessel was used for ozone testing, with three 254-nm bulbs in the first test, and two 254-nm bulbs and one 185-nm bulb in the second test.

Prior to beginning the ozone plus UV tests, two trials were conducted to determine the ability of ozone to oxidize sulfolane without UV radiation. The first trial involved bubbling ozone into a 1-liter amber jar containing sulfolane-impacted well water, then sealing the jar, shaking, and collecting a sulfolane sample. Total ozone contact time for this test was approximately 20 minutes. The second trial involved bubbling ozone into a 20-gallon tank while recirculating contaminated well water through the tank for mixing. A sulfolane sample was taken from the tank effluent at 30 minutes of reaction time.

The first ozone test utilized the UV unit with three 254-nm bulbs in one vessel. The feed water was recirculated through the mix tank and UV unit at a flow rate of 1 gpm. After 20 minutes of recirculation, a sample was collected from the effluent of the UV unit.

For the ozone tests with two 254-nm bulbs and one 185-nm UV bulb, the tests were conducted in a recirculation mode using the same equipment as the previous test, except that one of the 254-nm bulbs was replaced with a 185-nm bulb. However, three rounds of samples were collected instead of one. The timing of each sampling round was such that one, two, and three volume exchanges were completed through the system, respectively. As the recirculation rate was 1 gpm, the sampling intervals were 25, 50, and 75 minutes.

In each round, samples were collected from ozone effluent and UV effluent (which is also system feed, in recirculation mode). Before beginning the test, the feed was also sampled for sulfolane, TOC, iron, manganese, and alkalinity.

Bench Test Results

The activated carbon test results indicated that no sulfolane breakthrough was observed in any of the columns, suggesting that even the 12-minute EBCT achieved in the first column was sufficient to achieve sulfolane adsorption for both columns. Siemens carbon was utilized for the subsequent test at the 0.3-gpm feed rate. It was found that this carbon did not exhibit breakthrough in any of the columns at the 0.3-gpm feed rate during the initial 24-hour period, which suggests that an EBCT of about 4 minutes is sufficient to achieve sulfolane adsorption. As a 4-minute EBCT is typical for residential-sized carbon adsorption units, it was decided not to pursue a lower EBCT test, and instead move to testing time to breakthrough.

It was decided to continue testing the Siemens carbon for the breakthrough test. The carbon was loaded at a rate of 0.3 gpm for a period of 150 hours. Data from the carbon breakthrough test indicated that breakthrough began after 66 hours in the first column (approximately 7,000 gallons per cubic foot of activated carbon), while breakthrough was never observed in the other two columns. The sulfolane concentration continued to increase in the Column 1 effluent through the end of the test.

For the hydrogen peroxide plus UV tests, when the unit with three 254-nm UV bulbs in series was used sulfolane removal on the order of 30 percent was observed across the UV unit at a residence time of 2 minutes based on flow at 1 gpm. Replacing the three sequential bulbs with three in a single vessel improved sulfolane removal to nearly 40 percent at a residence time of 2 minutes based on a flow of 1 gpm. Additionally, data collected at the 1-minute and 1.5-minute residence times allowed the calculation of a first-order rate coefficient (0.15 min-1) for the oxidation reaction. Replacing one of the three 254-nm bulbs with a 185-nm bulb resulted in a faster rate for the oxidation reaction (0.21 min-1).

The oxidation-reduction potential (“ORP”) measurements recorded during the test with three 254-nm UV bulbs were lower than those measured during other tests. The source water location was the same for this test as to the other tests; however, it is believed that water from a more reduced zone was pulled into the well. This variability in the source water reduced species creates concerns for utilization of advanced oxidative processes such as hydrogen peroxide and ozone with UV.

For the ozone (with and without UV) tests, it was found that ozone alone achieved only 9-13% sulfolane removal. Additionally, the maximum dissolved-ozone concentration that could be achieved in any of the tests was only 0.5 ppm, which is significantly less than the saturation value of 20 mg/L in cold water. Additional modifications to the ozone supply system were completed to attempt to increase the dissolved-ozone concentration; however, these efforts were unsuccessful when using equipment that was sized to be used in a residential setting. Further, development of the ozone bench-testing setup also required additional ozone offgas control/destruction equipment to ensure the testing could be performed safely.

The combination of ozone plus UV yielded a sulfolane removal of approximately 30 percent based on the sulfolane concentration previously measured for this feed water. Replacing one of the 254-nm bulbs with a 185-nm bulb did not significantly increase the reaction rate for ozone.

Bench Testing Conclusions

Bench-testing results indicated that activated carbon adsorption was the most effective and most reliable treatment technology for sulfolane removal in residential well water. Based on the mass loading of sulfolane achieved prior to breakthrough, it was estimated that a standard 2.5-cubic-foot residential carbon filtration vessel would last between two and three months under normal single-family water usage rates for feed water having a sulfolane concentration of 350 ppb. This length of time is based on the bench test results that showed breakthrough at approximately 7,000 gallons per cubic foot of activated carbon. The majority of the homes where the POE treatment design could be implemented typically have sulfolane concentrations below 100 ppb, thus a standard 2.5-cubic-foot residential carbon filtration vessel could last much longer than three months for the majority of the residences. Therefore, the scale of the required carbon equipment is such that sufficient capacity and redundancy could be provided in a footprint that could be implemented in a residential setting. While some removal of sulfolane was achieved via ozone or hydrogen peroxide in conjunction with UV radiation, removal was not complete in the reaction times studied. It is likely that, in order to provide complete removal via these methods, larger UV reactors with greater UV intensity would be required. Thus, the scale of the required equipment would likely not be for a residential system.

In one embodiment, the purified water contains less than 10 ppb sulfolane. In other embodiments, sulfolane is not detectable in the purified water when tested in accordance with one or more industry standards for drinking water quality. One such standard is Modified EPA 8270 With Isotope Dilution, as performed by, e.g., Pace Analytical Services.

In other embodiments, the filtration system components comply with one or more of the following equipment standards: NSF/ANSI-53, as set forth by NSF International. Another standard is the Water Quality Association (“WQA”) Gold Seal Certification as tested against WQA Protocol TP.11003 for Sulfolane Reduction.

According to one embodiment of the invention, the activated carbon-based system is designed based one or more of the following parameters:
Average feed-water flow rate=240 gallons per day (four-person household, 60 gallons per person per day).
Peak feed-water flow rate=6 gpm, based on maximum anticipated instantaneous usage rate for single-family homes.
Maximum feed sulfolane concentration=350 μg/L, based on highest measured sulfolane concentration in residential well water (as referenced during bench testing).
Maximum feed suspended solids=1 mg/L, as recommended to prevent plugging of activated carbon beds.
Minimum feed-water temperature=3° C. (the anticipated minimum feed-water temperature).
Maximum feed-water iron concentration=0.05 mg/L, based on quality of water used for bench testing, and reasonably attainable performance for water softeners.
Maximum feed-water manganese concentration=1 μg/L, based on quality of water used for bench testing.
Maximum feed-water TOC concentration=2.5 mg/L, based on quality of water used for bench testing.
Minimum carbon EBCT=4 minutes−based on carbon bench test results.
Carbon sulfolane loading rate=0.019 lb sulfolane per cubic foot carbon, based on carbon bench-test results.
Carbon replacement frequency=6 months (assumed as a practical replacement interval to minimize imposition on homeowners).

It is believed that these parameters are conservative, as the actual per person water usage rate in contaminated areas (e.g., Alaska) may be less than the referenced average, and the majority of the homes in which these systems may be installed may have significantly less than 350 ppb sulfolane in their groundwater. It will be recognized that the design basis may vary from those parameters listed above as necessary.

While the maximum sulfolane concentration is expected to be no more than 350 ppb (μg/L), in some embodiments the groundwater will have less than 350 ppb sulfolane.

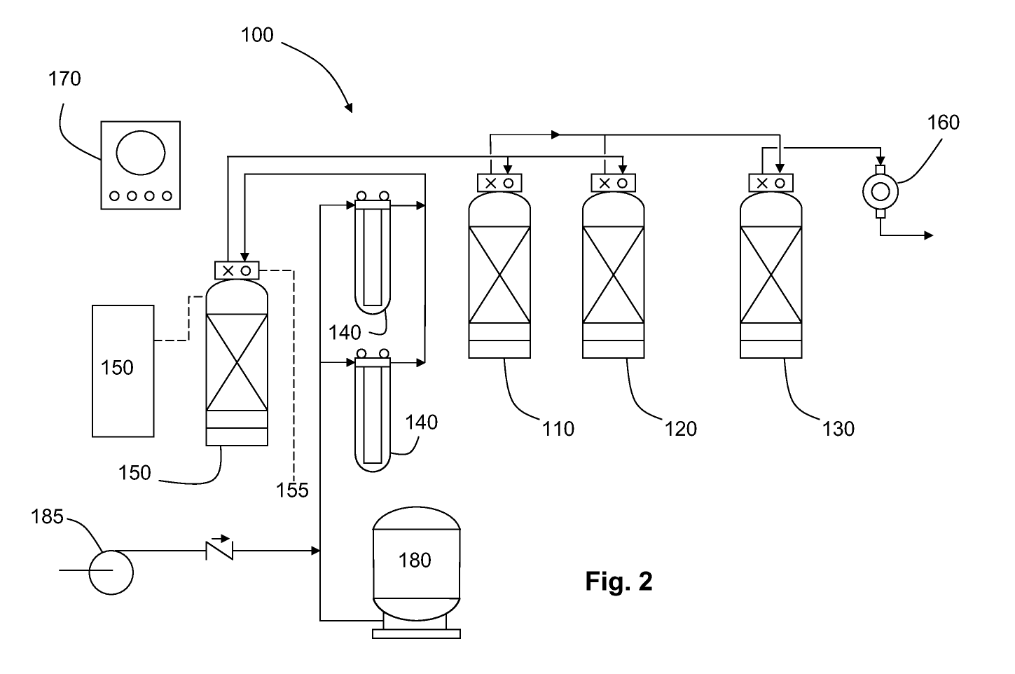

With reference to FIG. 2, filtration system 100 according to the present invention may include two primary carbon adsorption tanks 110, 120 and a secondary carbon adsorption tank 130. The secondary carbon adsorption tank 130 is suitable for final filtration/polishing.

As illustrated, the primary carbon adsorption tanks 110, 120 are in a parallel configuration. These tanks could, however, be provided in series as desired.

In certain embodiments, based on the design parameters described above each of the primary and secondary carbon adsorption tanks may be sized to contain 2.5 cubic feet of activated carbon. It will be recognized that other tank sizes/activated carbon loadings could be utilized based on other design parameters.

As explained above, under the conservative assumptions that are the basis for the design for certain embodiments, each 2.5 cubic foot carbon tank provides two to three months of sulfolane adsorption capacity. Therefore, in this embodiment the primary carbon adsorption tanks 110, 120 provide four to six months of capacity, and the secondary carbon adsorption tank 130 provides an additional two to three months of capacity, for a total capacity of six to nine months. It will be understood that the effective lifetime of the activated carbon could be extended if the sulfolane concentration in the incoming groundwater is less than 350 ppb.

In some embodiments, the activated carbon for use in primary carbon adsorption tanks 110, 120 and the secondary carbon adsorption tank will be granular activated carbon. Exemplary granular activated carbon forms include, but are not limited to, Norit® GCA 830 (available from Norit Americas Inc.), Aquacarb® 830C (available from Siemens AG), and combinations thereof. Norit® GCA 830 and Aquacarb® 830C are both 8×30 mesh carbon. Norit® GCA 830 is manufactured by steam activation, and Aquacarb® 830C is manufactured by direct activation. In certain embodiments, the activated carbon has an iodine number of from about 900 to about 1100 mg/g, an apparent density of from about 0.46 to about 0.54 g/cc, and a surface area (BET) of about 1150 m²/g. The activated carbon may be untreated—i.e., it does not require the use of an sulfolane remediation component such as a biological remediation component.

The filtration system 100 may optionally include one or more sediment filters 140 to remove suspended solids and a water softener 150 to remove iron. In addition to allowing reliable performance of the carbon system, the sediment filter 140 and water softener 150 will also improve the aesthetic quality of the water.

In some embodiments, the filtration system 100 will be housed within the structure where the filtered water will be consumed (e.g., the homeowner's residence). Where this is not feasible, the filtration system 100 may be housed in an out-building near the structure.

As illustrated in FIG. 2, the filtration system 100 includes two sediment filters 140 arranged in a parallel configuration. It will be understood, however, that only one sediment filter may be used, or more than two sediment filters may be used, and that multiple sediment filters can be arranged in a series configuration. An exemplary suitable sediment filter 140 is the Pentek® series S7562A filter, available from Pentair Water.

A suitable water softener is the ECR 3502 series water conditioner, available from EcoWater Systems. This water conditioner is NSF-certified for use in drinking water applications.

Exemplary primary carbon adsorption tanks 110, 120 include the EWS120CD series tanks available from EcoWater Systems. Similar NSF-rated units may also be used. The primary carbon adsorption tanks 110, 120 may be, but do not have to be, equipped with fully-programmable, electronic-demand control modules to record water usage and control backwashing frequency. As mentioned above, each unit may be charged with NSF-certified activated carbon. The units include automatic valves and piping to facilitate backwashing.

A suitable secondary carbon adsorption tank 130 includes the EWS120CS series tank available from EcoWater Systems. A similar NSF-rated unit may also be used. The secondary carbon adsorption tank 130 may be, but does not have to be, equipped with fully-programmable, electronic-demand control modules to record water usage and control backwashing frequency. As mentioned above, the unit may be charged with NSF-certified activated carbon. The unit includes automatic valves and piping to facilitate backwashing.

Other components, such as a totalizing flow meter 160 and a temperature and leak alarm system 170, may also be provided. The totalizing flow meter 160 is preferably NSF-certified for use in drinking water applications, and may include a remote reader to facilitate remote tracking of water usage. The temperature and leak alarm system 170 provides indication of possible problems to the customer and/or the vendor.

An exemplary description of the operation of the filtration system 100 will now be provided. In one embodiment, feed water flow may be delivered to the system through the customer's existing pressure tank 180. Feed from a well pump 185 may be delivered to the pressure tank 180 to maintain a feed pressure of approximately 30 to 50 psi.

Sediment larger than about 20 microns in size will be filtered from the feed water by the sediment filters 140. Change-out of the sediment filter cartridges will occur approximately every six months, or whenever the customer observes a pressure drop across the filter unit of 15 psi.

The water will then pass through the water softener 150, where hardness and iron will be removed. The water softener 150 will periodically recharge with sodium chloride brine from the system's brine tank (not shown), with the spent brine being routed to the sanitary sewer connection 155. Regeneration frequency will be paced to water consumption, as measured by the softener's digital demand module, at a rate determined by water analysis (i.e., hardness and iron concentrations).

The water will then pass through the primary carbon adsorption tanks 110, 120, where sulfolane and other naturally occurring organics will be removed via adsorption to the activated carbon. The primary carbon adsorption tanks 110, 120 may be automatically backwashed every seven days, with one tank being backwashed and the other tank remaining in service to supply the source water for backwashing the offline tank and treated water supply to the customer. In one embodiment, the total duration of backwashing will be 20 minutes, and backwash events may be timed to occur during off-peak water usage times. Backwash waste will be routed to the sanitary sewer connection (not shown). Carbon will be changed out of both primary carbon adsorption tanks 110, 120 every six months by replacing the tanks with newly rebedded and disinfected tanks. Sulfolane concentrations will be monitored at a sample tap located downstream of the primary tanks to confirm that sulfolane breakthrough does not occur between carbon change-out events.

The water will then pass through the secondary carbon adsorption tank 130, where any sulfolane that might break through prior to change-out of the primary carbon adsorption tanks 110, 120 will be removed from the water. In certain embodiments, the secondary carbon adsorption tank 130 will not be backwashed, although a manual backwash line may be provided (not shown) to allow flushing the tank to remove carbon fines and expand the carbon bed. Change-out of the secondary carbon adsorption tank 130 may occur every 18 months by replacing the secondary carbon adsorption tank 130 with a newly rebedded and disinfected tank. The effluent may be sampled every six months for fecal coliform to detect any microbial growth that may occur on the carbon filter. If fecal coliform are detected in the effluent, the secondary carbon adsorption tank 130 can be replaced with a newly-rebedded tank. Sulfolane concentrations will be monitored downstream of the secondary carbon adsorption tank 130 to confirm that sulfolane breakthrough does not occur.

Total flow through the system may be tracked using the totalizing flow meter 160. The temperature leak and alarm system 170 may include a moisture sensor that will be mounted at a low point, such as a floor drain, in the vicinity of the system. If moisture is detected, the temperature leak and alarm system 170 will advise the customer and the vendor(s). Likewise, if temperatures drop below preset temperatures in the space housing the system, the temperature leak and alarm system 170 will advise the customer and the vendor(s).

The filtration system according to the embodiments described herein thus provide a point-of-entry (POE) based system for removing sulfolane from groundwater utilizing untreated activated carbon as the filtration media. The sulfolane is removed from the water so that the water meets NSF standards for drinking water quality.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

We claim:

1. A method for removing sulfolane from sulfolane-contaminated groundwater, comprising passing the sulfolane-contaminated groundwater through a filtration system to form purified water, wherein the filtration system comprises activated carbon and the purified water is drinking water quality.

2. The method of claim 1, wherein the purified water comprises less than 10 parts per billion sulfolane.

3. The method of claim 2, wherein the concentration of sulfolane in the purified water is determined according to a Modified EPA 8270 With Isotope Dilution standard.

4. The method of claim 1, wherein the filtration system complies with NSF/ANSI-53 or Water Quality Association Gold Seal Certification as tested against WQA Protocol TP.11003 for Sulfolane Reduction.

5. The method of claim 1, wherein the filtration system comprises untreated activated carbon.

6. The method of claim 1, wherein the untreated activated carbon does not include a biological remediation component.

7. The method of claim 1, wherein the filtration system is a point-of-entry system.

8. The method of claim 1, wherein the filtration system is installed in a residential location.

9. The method of claim 1, wherein the filtration system comprises one or more primary carbon adsorption tanks and at least one secondary carbon adsorption tank.

10. The method of claim 9, wherein the one or more primary carbon adsorption tanks and the at least one secondary carbon adsorption tank comprise granular activated carbon.

11. The method of claim 9, wherein the filtration system further comprises a sediment filter and a water softener.

12. The method of claim 1, wherein the sulfolane-contaminated groundwater is passed through the filtration system at a maximum flowrate of about 6 gallons per minute.

13. The method of claim 1, wherein the sulfolane-contaminated groundwater has a sulfolane concentration of up to 350 parts per billion.

14. The method of claim 1, wherein the filtration system comprises two primary carbon adsorption tanks and one secondary carbon adsorption tank, and the two primary carbon adsorption tanks are arranged in a parallel configuration.

15. A method for removing sulfolane from sulfolane-contaminated groundwater, comprising passing the sulfolane-contaminated groundwater through a filtration system to form purified water, wherein the filtration system comprises activated carbon having no biological remediation component, the purified water is drinking water quality, and the filtration system is a point-of-entry system installed in a residential location.

16. A method for removing sulfolane from sulfolane-contaminated groundwater, comprising passing the sulfolane-contaminated groundwater through a filtration system to form purified water, wherein the filtration system comprises one or more primary carbon adsorption tanks and at least one secondary carbon adsorption tank, each of the one or more primary carbon adsorption tanks and secondary carbon adsorption tank charged with a sulfolane remediation component consisting of granular activated carbon.
